(19) United States
(12) Patent Application Publication
(10) Pub. No.: US 2025/0292184 A1
(43) Pub. Date: Sep. 18, 2025

(54) SYSTEM FOR AUTOMATED KNOWLEDGE ASSET DISCOVERY, GRAPH-BASED REPRESENTATION, AND TEMPORAL IDEA PROGRESSION MODELING

(71) Applicant: IP Copilot, Inc., Columbia, TN (US)

(72) Inventors: Austin Grant Walters, Columbia, TN (US); Jeremy Edward Goodsitt, Champaign, IL (US); Grant Mitchell Eden, San Francisco, CA (US); Jason Harrier, Columbia, TN (US)

(21) Appl. No.: 19/079,340

(22) Filed: Mar. 13, 2025

Related U.S. Application Data
(60) Provisional application No. 63/564,832, filed on Mar. 13, 2024.

(51) Int. Cl. G06Q 10/0639; G06F 16/93; G06N 5/022

(52) U.S. Cl. CPC G06Q 10/06395; G06F 16/93; G06N 5/022

(57) ABSTRACT

Various embodiments are generally directed to embodiments discussed herein. An example system includes a processor, and a memory having instructions stored therein. The instructions include a discovery module, a mapping module, an assignment module, a tracking module, a chunking module and an evolution module. When the instructions are executed by the processor, the instructions cause the processor to: monitor, by using the discovery module, documents within document repositories and communications in one or more communication media; identify, by using the discovery module, ideas in the monitored documents and communications; map, using the mapping module, knowledge within an enterprise based on the monitored documents and communications; provide, using the tracking module, tracking and management of the identified ideas; chunk, using the chunking module, the monitored documents and communications to provide context of the identified ideas; and track, using the evolution module, progression of the identified ideas over time.

### CROSS-REFERENCE TO RELATED APPLICATIONS

This application claims a priority to U.S. Provisional Patent Application Ser. No. 63/564,832, entitled “ARTIFICIAL INTELLIGENCE DRIVEN EVALUATION, TRACKING, AND MANAGEMENT OF INSTITUTIONAL KNOWLEDGE” filed on Mar. 13, 2024. The contents of the aforementioned application are incorporated herein by reference in their entirety.

### TECHNICAL FIELD

The subject matter described relates generally to artificial intelligence tools and, in particular, to systems and methods for artificial intelligence driven evaluation, tracking, and management of institutional evaluating.

### SUMMARY

Embodiments include a method and system including a processor and memory containing several computational elements or processors to to perform discovery, management, and analysis of ideas within an enterprise system. The system monitors document repositories and communication media, identifying and extracting new ideas. The system then constructs a knowledge map of the enterprise based on these monitored sources. The system also provides tools for managing and tracking the identified ideas, while a chunking process provides context by breaking down the original documents and communications. Finally, the system tracks the progression and development of these ideas over time, providing insights into their lifecycle and impact.

### BRIEF DESCRIPTION OF THE DRA WINGS

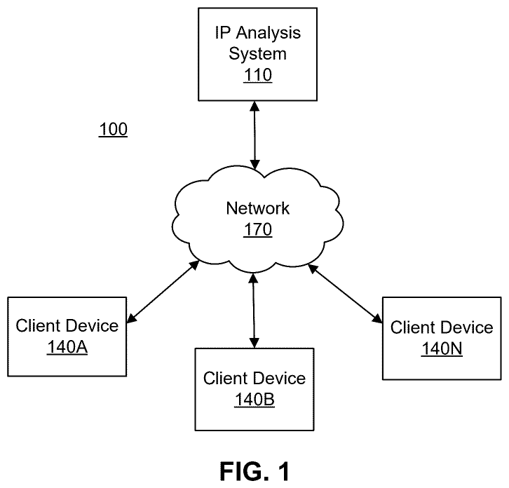

FIG. 1 is a block diagram of a networked computing environment in which institutional knowledge may be evaluated, tracked, or managed, according to one embodiment.

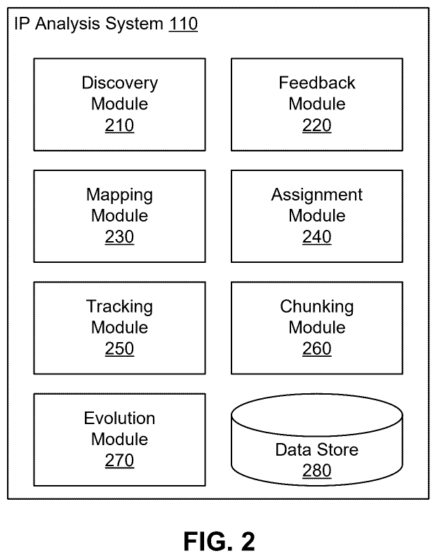

FIG. 2 is a block diagram of the knowledge analysis system of FIG. 1, according to one embodiment.

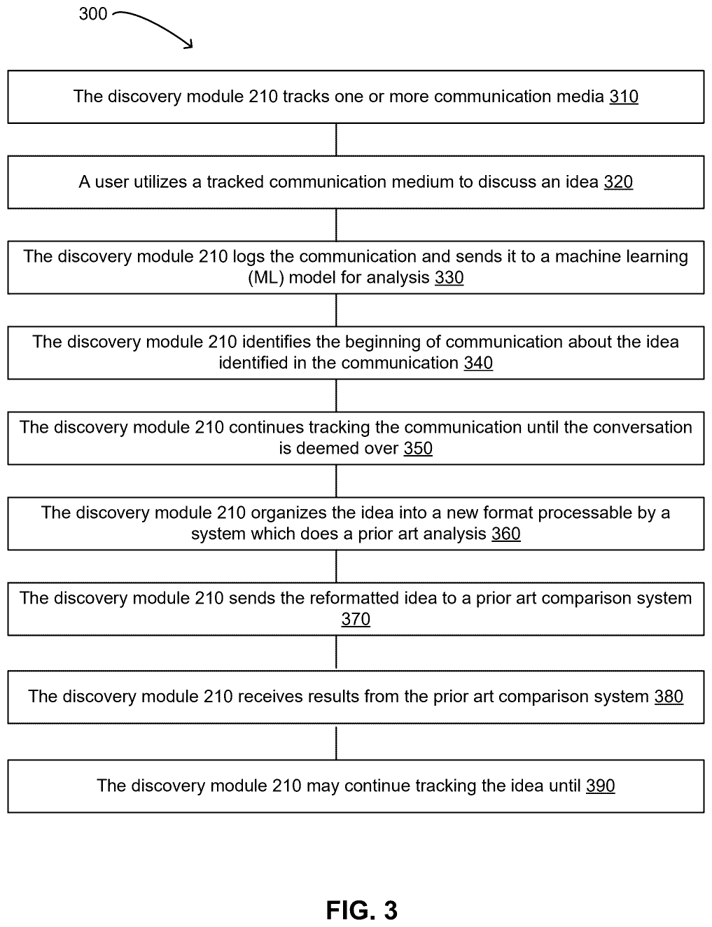

FIG. 3 is a flow chart of a method performed by the knowledge analysis system of FIG. 1, according to one embodiment.

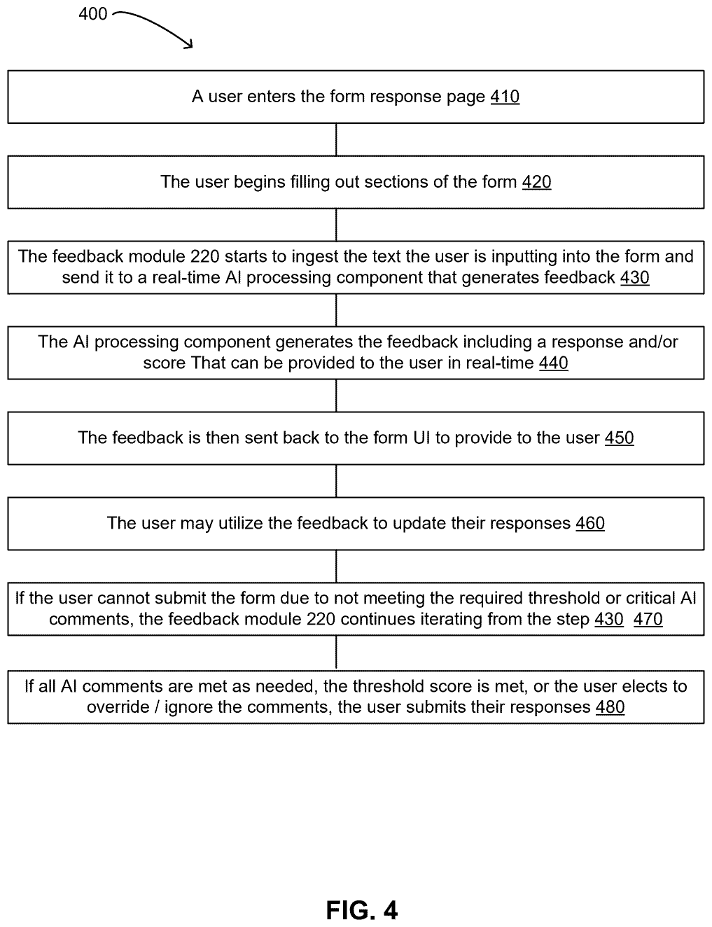

FIG. 4 is a flow chart of a method performed by the knowledge analysis system of FIG. 1, according to one embodiment.

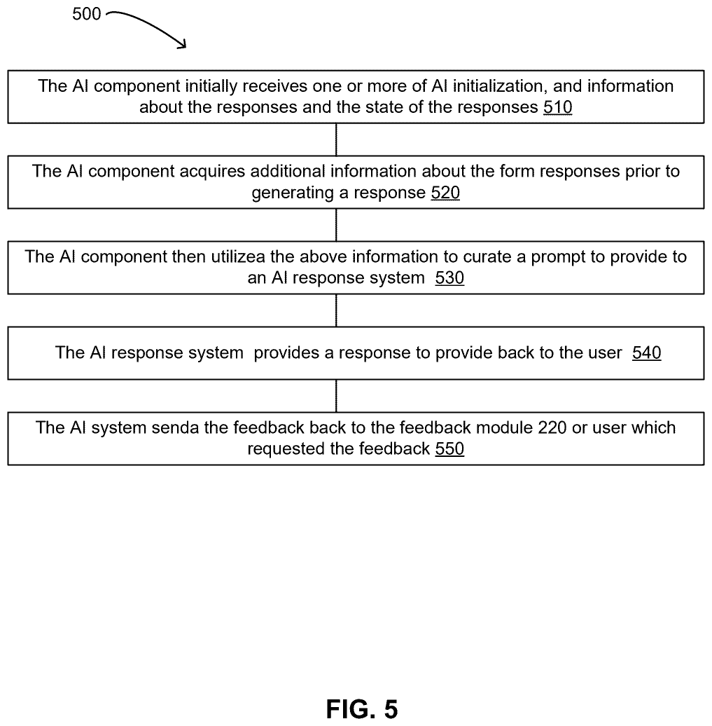

FIG. 5 is a flow chart of a method performed by the knowledge analysis system of FIG. 1, according to one embodiment.

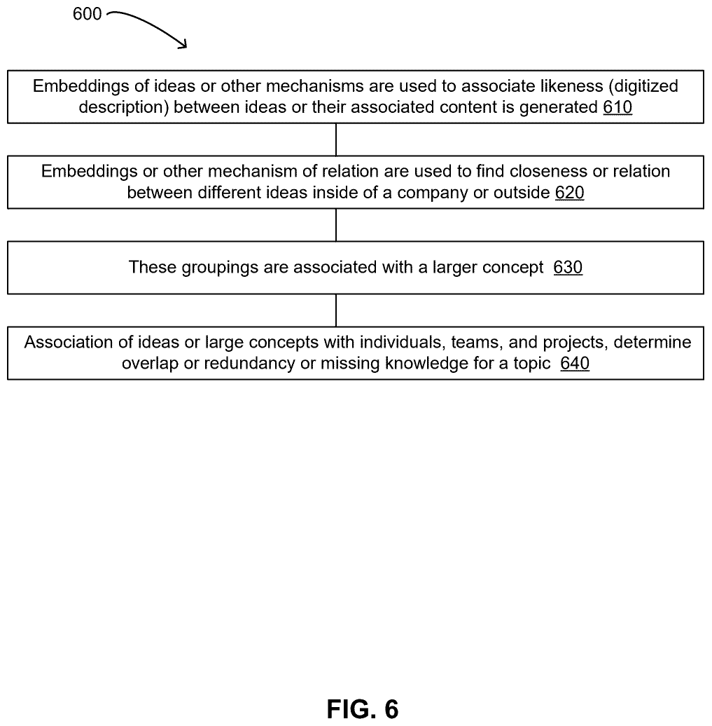

FIG. 6 is a flow chart of a method performed by the knowledge analysis system of FIG. 1, according to one embodiment.

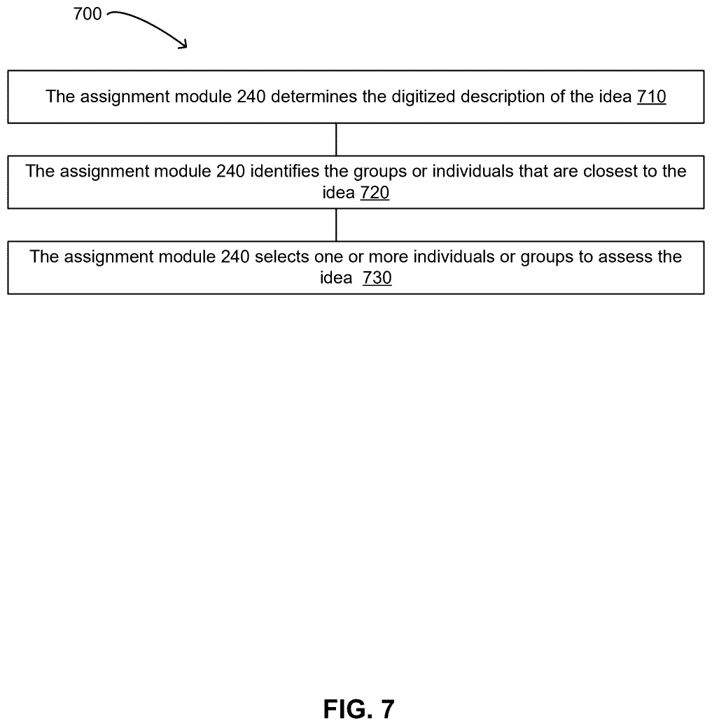

FIG. 7 is a flow chart of a method performed by the knowledge analysis system of FIG. 1, according to one embodiment.

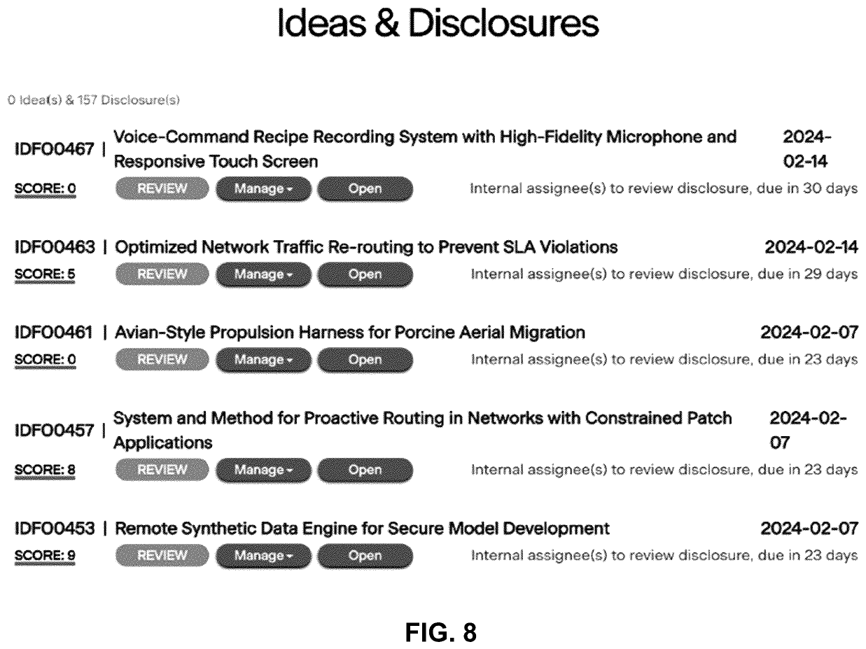

FIG. 8 shows an example ideas list generated by the knowledge analysis system for an employee, according to one embodiment.

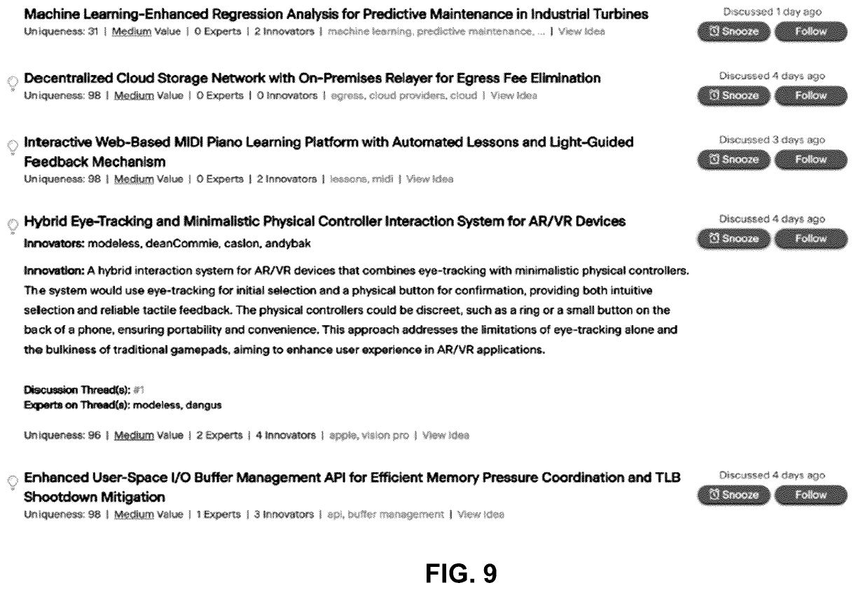

FIG. 9 shows an example ideas dashboard showing a set of ideas being tracked by the knowledge analysis system, according to one embodiment.

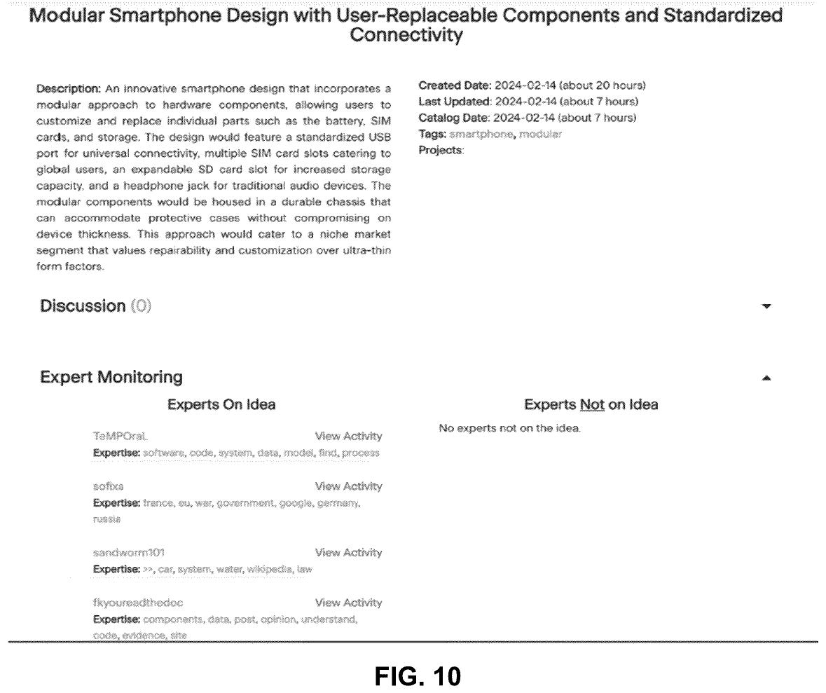

FIG. 10 shows an example notification that summarizes an idea and who has been working on it, according to one embodiment.

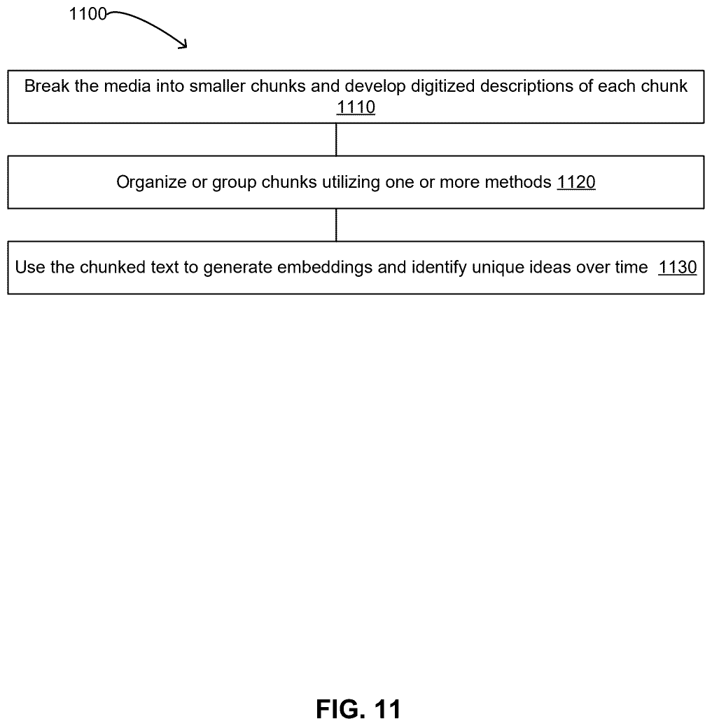

FIG. 11 is a flow chart of a method performed by the knowledge analysis system of FIG. 1, according to one embodiment.

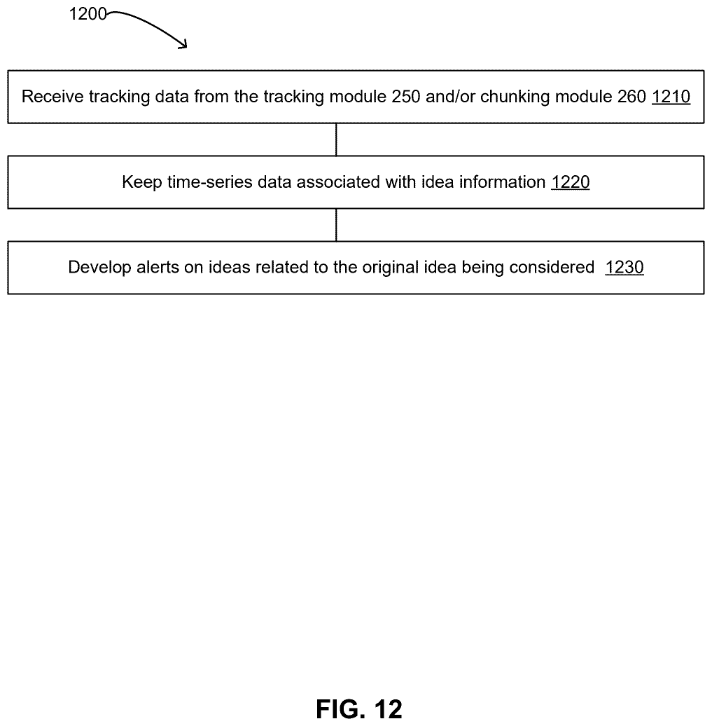

FIG. 12 is a flow chart of a method performed by the Knowledge analysis system of FIG. 1, according to one embodiment.

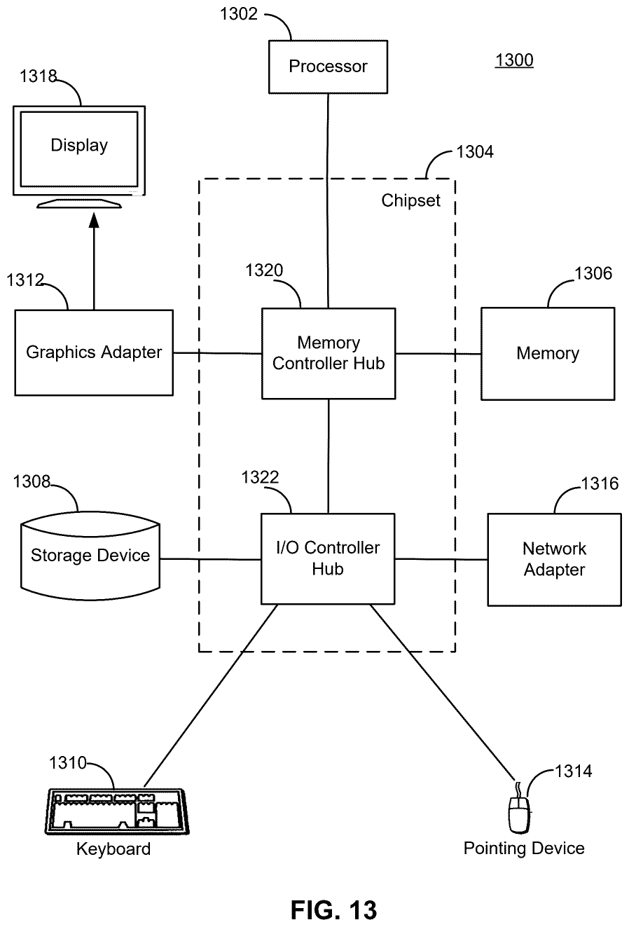

FIG. 13 is a block diagram illustrating an example computer suitable for use in the networked computing environment of FIG. 1, according to one embodiment.

### DETAILED DESCRIPTION

This system and method embody a sophisticated, processor-driven architecture designed for the automated discovery, management, and analysis of institutional knowledge, with a particular emphasis on intellectual property (IP) asset lifecycle tracking. Employing a modular design, the system integrates a suite of advanced computational techniques to process and interpret unstructured data from document repositories and communication media. The discovery module leverages natural language processing (NLP) algorithms, including entity recognition, topic modeling, and semantic similarity analysis, to extract and identify emerging ideas. These extracted ideas are then transformed into structured representations suitable for further analysis.

One aspect lies in its ability to construct and manipulate dynamic knowledge graphs. For example, the system may utilize embedding techniques, such as word embeddings and document embeddings, alongside graph neural networks (GNNs), to create a rich, interconnected representation of knowledge within the enterprise. This knowledge graph captures relationships between ideas, authors, documents, and other relevant entities, enabling complex queries and inferences. The system may also perform chunking to contextualize extracted ideas by employing contextual windowing and discourse analysis, ensuring that related discussions are linked together and that the semantic integrity of ideas is preserved. Further, the system tracks the temporal progression of ideas through time-series analysis and graph diffusion models, allowing for the visualization and analysis of idea propagation and development.

Furthermore, the system incorporates intelligent assignment and feedback mechanisms. For example, the system utilizes large language models (LLMs) to generate technology tags for potential inventions, and then employs embedding-based similarity searches to route these inventions to appropriate portfolio managers or patent committees. This process can utilize pre-generated classification maps or nearest-neighbor searches in embedding space, optimizing the allocation of expertise. The system enhances invention disclosure submissions by automating prior art searches and generating targeted questions based on the identified gaps in prior art. The system also generates predictions and recommendations by traversing the knowledge graph and extrapolating from embedding spaces, identifying knowledge overlaps, assessing business value, and forecasting research trends. Knowledge audits are generated through database queries on tags, embeddings, and descriptions, while idea spread is monitored through access control and sharing patterns. Additionally, the system performs infringement detection by comparing product feature descriptions with existing IP representations. Expertise profiles are generated using topic modeling and key term analysis on manager/committee documents. This system is implemented both as a hardware-software system and as a series of methods and computer-readable instructions, designed to automate and optimize the management of institutional knowledge and IP assets.

The technical advantages of this system stem from its sophisticated integration of advanced computational techniques for knowledge management and intellectual property (IP) analysis. Automated semantic analysis, powered by natural language processing (NLP), enables the system to transcend keyword-based searches, capturing nuanced meaning and context. Contextualized idea extraction, achieved through the chunking contextual windowing and discourse analysis, prevents information loss and enhances interpretation accuracy. Real-time monitoring ensures rapid identification of emerging trends, offering a competitive edge. Robust knowledge representation is achieved through dynamic knowledge graph construction, utilizing embedding techniques and graph neural networks (GNNs), facilitating complex queries and inferences. Embedding-based similarity searches enable efficient identification of related ideas, while temporal knowledge tracking, via time-series analysis and graph diffusion models, provides insights into idea evolution. Intelligent assignment and routing, facilitated by LLM-powered technology tagging and embedding-based expertise matching, optimize patent portfolio management and caseload distribution. Improved invention disclosure and IP management are realized through prior art searches, proactive infringement detection, and comprehensive IP asset tracking. Advanced analytics and prediction capabilities, including knowledge graph traversal, extrapolation in embedding space, and automated knowledge audits, provide valuable insights and forecasts. Finally, the system's modular design, and processor-executed real-time processing, ensure flexibility, performance, and reliability.

In some instances, the system distinguishes itself from contemporary knowledge management and IP analysis systems through its comprehensive integration and real-time monitoring. Unlike solutions that address isolated aspects, this system offers an end-to-end workflow without user intervention, spanning from initial idea discovery to patent portfolio management and predictive trend analysis. One differentiator is its construction of a unified knowledge graph, merging information from diverse sources into a holistic view, contrasting with the fragmented data silos common in existing systems. The system's reliance on advanced AI and machine learning techniques, such as deep learning for semantic analysis, embedding-based similarity searches, and dynamic contextual chunking, surpasses traditional keyword-based or rule-based methods. Its proactive and predictive capabilities, including automated infringement detection and trend forecasting, provide a strategic advantage by anticipating potential risks and opportunities. Enhanced invention disclosure and feedback mechanisms, featuring computerized prior art searches and clarity scoring, significantly improve submission quality. Furthermore, the system offers granular knowledge tracking and auditing, enabling temporal idea evolution analysis and detailed expertise assessments, along with tracking who knows what. This holistic, AI-driven approach represents a significant advancement, empowering organizations to gain deeper insights into their intellectual assets and make more informed strategic decisions.

The figures and the following description describe certain embodiments by illustration only. One skilled in the art will readily recognize from the following description that alternative embodiments of the structures and methods may be employed without departing from the principles described. Wherever practicable, similar or like reference numbers are used in the figures to indicate similar or like functionality. When elements share a common numeral followed by a different letter, the elements are similar or identical. A reference to the numeral alone generally refers to any one or any combination of such elements unless the context indicates otherwise.

FIG. 1 illustrates one embodiment of a networked computing environment 100 in which institutional knowledge may be evaluated, tracked, or managed. In the embodiment shown, the networked computing environment 100 includes a knowledge analysis system 110 and one or more client device 140 (140A, 140B and 140N), all connected via a network 170. Although three client devices 140A-N are shown, the networked computing environment 100 can include any number of such devices. In other embodiments, the networked computing environment 100 can include different or additional elements. In addition, the functions may be distributed among the elements in a different manner than described.

The knowledge analysis system 110 can include one or more computing devices that analyze communications, invention disclosure forms, and/or other documents to identify potential institutional knowledge and evaluate, manage, and/or track identified knowledge. For example, the knowledge analysis system 110 may build an idea map of who has what knowledge, assign potential IP to portfolio managers or committees for further evaluation, track IP contributions of individuals or groups to the enterprise, chunk together communications that refer to the same or similar ideas, or track the progress of ideas over time. The knowledge analysis system 110 may include a discovery process. The discovery process may include knowledge discovery, ideas identification, and invention disclosure or trade secret generation, which can lead to more robust invention disclosures. The functionality provided by various example embodiments of the knowledge analysis system 110 is described in greater detail below, with reference to FIG. 2.

A client device 140 may be a computing device with which a user directly or indirectly interacts with the knowledge analysis system 110. A client device 140 may be used to review analysis performed by the knowledge analysis system 110, submit invention disclosures, review feedback on submitted invention disclosures, communicate with other client devices 140 (e.g., using email, instant messenger, or video conference, etc.), and/or access any other functionality provided by the knowledge analysis system 110. The knowledge analysis system 110 may monitor communications between client devices 140 and/or documents created by client devices 140 to identify potential IP for further analysis.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the knowledge analysis system 110 of FIG. 1. In the embodiment shown, the knowledge analysis system 110 includes a discovery module 210, a feedback module 220, a mapping module 230, an assignment module 240, a tracking module 250, a chunking module 260, an evolution module 270, and a data store 280. In other embodiments, the knowledge analysis system 110 may include different or additional elements. In addition, the functions may be distributed among the elements in a different manner than described.

The discovery module 210 uses communication medium monitoring software to identify current conversations that could convert into an enterprise's IP asset or provide warnings where the development of a feature under development within the enterprise may lead to infringement of existing IP. Application programming interfaces (APIs) can be utilized into external communication systems to retrieve relevant data regarding communication. For a cloud-based team collaboration tool, such as Slack™, webhooks, can be received with new/updated/deleted text via event driven communications. Other team workspace tool, such as Confluence™, instead of webhooks, a time-based job scheduler can generate jobs, e.g., a cron job, that can be run daily which searches for new content/updated content to process via an API. For data that is updated and not new, differences between the new and old data can be identified to parse what is changed and update the monitoring system with the difference. Alerts may be triggered automatically when certain criteria are met (e.g., a communication message on the idea, email with the conversation and patentability score, alert to the internal IP counsel, etc. All communications can be stored, or communications can be stored selectively based on the patentability if desired. In either case, the communication data is reviewed after storage. Metadata associated with communication data allows for linking to previous comments and or ideas. A model or embeddings can be used to determine if it is linked to the same or different idea. If the communication data is new, the model can be used to determine if they are valuable. APIs generally have webhooks, so alerts of new data are handled automatically by third parties hitting our endpoints with triggers on new communication data in their system. In other embodiments, a daily/weekly scan can be set up for new data and process it. Additionally or alternatively, a summary of an invention or draft of a patent application on an invention may be automatically generated on detection of a new idea (e.g., using a generative large language model).

In one embodiment, the discovery module 210 may perform a method 300 and work as follows. The steps in method 300 may be performed sequentially or out of order, or may be combined.

At step 310, the discovery module 210 tracks one or more communication media, such as communications platforms or tools for workplace chat and/or video conferencing. At step 320, the discovery module 210 receives one or more user inputs of a discussion about ideas on a tracked communication.

At step 330, the discovery module 210 logs the communication and sends it to a machine learning (ML) model for analysis, including the generation of a score or categorization, etc. In some embodiments, a large language model (LLM) can be inquired to generate a technical merit score on a cohort of text that was chunked together. In some other embodiments, a classical machine learning (ML) model can be used to score based on words. In yet some other embodiments, Flesch-Kincaid can be used to grade on the text. In still yet some other embodiments, it can be binary based on categorization allowing the model to do its own scoring internally which was trained on technical and non-technical text. If the communication does not meet a threshold score, categorization, etc. of the ML model, the discovery module 210 stops analysis. If the discovery module 210 is unsure (e.g., if a score is below a first threshold but above a second threshold), the discovery module 210 may wait for more communication to better categorize the initial communication. If the communication meets the threshold, the discovery module 210 continues on to step 340.

At step 340, the discovery module 210 identifies the beginning of communication about the idea identified in the communication. At step 350, the discovery module 210 continues tracking the communication until the conversation is deemed over. For example, the conversation may be considered to be over in the following situations: (1) a certain period of time has passed since the last conversation (maybe user dependent); and/or (2) a conversation switch is detected over a certain number of continued communications. Specifically, this can be embedding based to determine the likelihood of the conversation switch. Additionally, since conversations happen async, a continued conversation may swap back and forth between conversation topics in sequential communications. Using context identifiers to group text together or to each respective conversation idea/topic can mean that non-sequential conversations may still continue a conversation. In some embodiment, the communication may be tracked over multiple mediums. In some embodiments, even if a communication is deemed over, a new communication may be added to a previous idea if it is determined later to be discussing the same invention.

At step 360, the discovery module 210 organizes the idea into a new format processable by a system that does a prior art analysis. This may be in the form of an invention disclosure. This may be in the format of a processable format for a large language model. This may be in the format processable by another ML model. This may be converted into an embedding that describes the idea in vector form for comparison to other ideas. The embeddings can be generated from embedding models or the token embedding layer from an LLM. More generally, this may be converted into a comparable format, allowing it to be compared against the prior art or each other.

At step 370, the discovery module 210 sends the reformatted idea to the prior art comparison system. The prior art comparison system may utilize the classification of ideas to narrow a prior art search. The comparison system may utilize any of the ideas format described in step 360 to conduct a prior art search. The prior art comparison system may return a classification of the idea; prior art close to the idea, including internal or external prior art; questions to ask about the idea; a business eligibility score or ranking of the idea; a score on patentability (combination of the above or additional values), etc. In some instances, one or more of these operations may be performed by separate and different modules. For example, embodiments may include a classification module to classify an idea. A classification module is a computational system designed to process and categorize invention concepts by assigning them to predefined classes or labels. It functions by transforming invention ideas into computable representations, encompassing textual descriptions, structured feature sets, or vector embeddings. Subsequently, it extracts relevant features from these representations, such as keywords, semantic relationships, technical classifications, and numerical metrics representing complexity or novelty. A classification algorithm, leveraging techniques like supervised machine learning, rule-based systems, or hybrid approaches, then maps these features to the predefined categories, producing an output of discrete labels with associated confidence scores. Performance is rigorously evaluated using metrics like precision, recall, and accuracy to ensure reliable categorization. In some instances, the module integrates with extensive knowledge bases, like patent databases, and employ natural language processing to enhance understanding of the invention's text and assess its novelty and non-obviousness.

Embodiment may also include an art unit prediction module to forecast the likely art unit within a patent office that would be assigned to a new patent application. This system operates by processing diverse input data, including application text, drawings, and applicant information, extracting relevant features through natural language processing and technical analysis. These features, encompassing keywords, IPC codes, and conceptual relationships, are then fed into a machine learning model, such as a neural network or support vector machine, trained on historical patent data. The module's output consists of a predicted art unit or a ranked list of potential units, accompanied by confidence scores. Performance is rigorously evaluated using metrics like accuracy and precision. The system's technical complexity necessitates handling the variability of patent language and adapting to evolving classification structures, often integrating with other patent analysis tools to facilitate efficient patent examination and routing.

Embodiments may further include a detectability module. In some instances, the system may include a business value module. A business value module for ideas serves as a structured framework for quantifying the potential economic and strategic worth of new concepts. This computational system aims to transform abstract ideas into tangible business metrics, enabling organizations to make informed investment and prioritization decisions. It operates by capturing and representing ideas in standardized formats, followed by rigorous market analysis, technical feasibility assessments, and financial modeling. Key financial metrics like ROI and NPV are calculated, and potential risks are identified and assessed. The module also evaluates strategic alignment with organizational goals and employs scoring models to rank ideas based on their potential value. Ultimately, it generates comprehensive reports and visualizations, providing actionable insights for decision-making. The technical design emphasizes flexibility, integration with relevant data sources, and transparency, ensuring consistent and auditable evaluations.

A patent detectability module that analyzes the difficulty of identifying infringement focuses on assessing the inherent challenges in detecting potential violations of an invention idea, rather than its presence in prior art. This specialized computational system evaluates the invention's technical features and implementation details, identifying aspects that may be obscured or difficult to reverse-engineer. It analyzes the scope and ambiguity of potential patent claims, assessing potential loopholes that could hinder infringement detection. The module also evaluates the complexity of implementing the invention in real-world scenarios, assessing how easily infringement can be hidden through variations. Furthermore, it analyzes the challenges of gathering evidence, assigning scores to detectability factors like claim ambiguity and implementation complexity. Scenario analysis is used to create hypothetical situations, and test the ability to prove infringement. The system generates reports highlighting potential challenges and recommending strategies for strengthening patent claims or improving infringement monitoring. This module emphasizes the practical challenges of patent enforcement, focusing on how easily potential infringers can hide their actions and how difficult it is to prove infringement.

At step 380, the discovery module 210 receives results from the prior art comparison system. If the value of patentability is below a given threshold or criteria, no further action is taken unless the idea gains new context. In some embodiments, if the prior art comparison system is unsure or needs further explanation it may provide questions to ask the user. This can be done through prompt tuning to ask the LLM to provide scores of confidence on output and thresholding scores to determine if more questions need to be asked. In some embodiments, the AI can be asked if more questions are worth to understand desired information which is important for the comparison. If the desired information is not properly answered, then it can develop questions to get the desired information where needed. If no questions are provided, the discovery module 210 may inform the user(s) communicating that they may have a new idea or ask the user(s) generic questions about the idea. If questions are provided, a chat system or dialog system may utilize the questions to continue a conversation with the user.

In some embodiments, when the value of patentability is high, if questions are provided, the discovery module 210 may ask the user(s) communicating the questions. The idea is logged as a patentable idea. A disclosure form may be drawn up for the user(s). A link to the disclosure form can be provided to the user(s), and continued communication about the idea can be tracked by the discovery module 210 and added to the disclosure form automatically (users can select to have comments removed if not related). The discovery module 210 may inform the user(s) communicating it is a patentable idea via the same or new communication medium. The discovery module 210 may alert internal counsel for review. The discovery module 210 may automatically push to internal counsel for review, which can utilize classification or previous work by external firms to determine the best firm to send the disclosure to.

At step 390, the discovery module 210 may continue tracking the idea until one or more of the following events occur: (1) the idea is deemed no longer viable by inventors, attorneys, company, etc.; (2) new information determines it is not viable (e.g., prior art, continued conversation, business value, internal/external firm denies, etc.); (3) a patent application about the idea is submitted to the USPTO; and/or (4) the AI analysis system receives any indication that it no longer should track the idea.

In addition, in some embodiments, the discovery module 210 may discover patentable concepts within an organization based on content and conversations. The discovery module 210 may pull documents, messages, emails, etc., split the pulled content based on sections, and identify unique patentable ideas based on, for example, an embedding search. In some embodiments, rudimentary searches can be performed as well. e.g. ts_vector or any text lookup. It can all be thrown into an AI and asked to give results or do reasoning. The discovery module 210 may also determine if the author of a communication has sufficient knowledge and expertise to create an invention in a given technology space.

The feedback module 220 applies artificial intelligence to enhance form submissions by knowledgeable or new users of the form. The feedback module 220 may utilize real-time feedback given to users at the time of filling out their form.

In one embodiment, the real-time feedback may provide insight on the clarity of one or more form responses in communicating their idea to the prompt associated with the response. For example, the feedback may include details of how to improve communication (e.g., bullet points, numbered lists, questions about their response with respect to the question, etc.). The feedback may include clarity for a specified reviewer/editor of their response and/or intended recipient of their response. The feedback may include no feedback necessary as the user responses are clearly communicated.

In another embodiment, the real-time feedback may provide insight on the user's response with respect to known topics, ideas, or communications in a similar area. For example, the feedback may include questions about the response and how it separates from existing topics in the case of prior art searches for duplicity. The feedback may include questions for clarity which provide more nuanced detail based on known ideas in the response subject area. The feedback may include instructions for aspects of the response to elaborate. The feedback may include prior art that may include existing patents, publications, other IDFs, internet forums, voice communications, videos, etc. The feedback may include no feedback necessary as the ideas or separation with respect to the known art is clear. In some embodiments, once an idea has been discovered, an inventor can generate an invention disclosure with a click. They can then edit it. In some other embodiments, an AI agent can generate a form which allows inventors to share ideas and does a real-time prior art search, providing questions and feedback. The AI agent has the context of the prior art as it asks the questions. For example, if an inventor shares three elements, A B C, and the only unique portion is B, the AI agent will focus on requesting technical details on B, since that is most likely to be the new portion of the invention.

In yet another embodiment, the real-time feedback may provide insight on a score for the quality of the responses, such as clarity, prior art conflict, validity of the idea, business score evaluation, and so forth.

In one embodiment, the feedback module 220 may perform a method 400 and work as follows. The steps in method 400 may be performed sequentially or out of order, or may be combined.

At step 410, a user enters the form response page. At step 420, the user begins filling out sections of the form. Sections of the form may include: title, problem, solution, prior art, description, summary/abstract, novelty, business value, questions about the topic, etc.

At step 430, the feedback module 220 may start to ingest the text the user is inputting into the form and send it to a real-time AI processing component that generates feedback. Ingestion may be done on a cadence. Ingestion may be done after clicking out of a box. Ingestion may be done when a certain number of words or characters are provided.

At step 440, the AI processing component generates the feedback including a response and/or score that can be provided to the user in real-time. At step 450, the feedback is then sent back to the form user interface (UI) to provide to the user. The UI may show animated elements to show the AI processing. The UI may highlight to the user the AI feedback.

At step 460, the user may utilize the feedback to update their responses. For example, the AI may suggest that the responses are in a quality state and the user hits a “submit” button on the UI. The AI may suggest the responses need updates, which the user ignores. The feedback module 220 can prevent submission for scores below a threshold. The feedback module 220 can prevent submission until specific points are addressed (some AI comments may have varying scores of needing to address; this is different than a total response score). The feedback module 220 may allow a user override. The AI may suggest updates that the user attempts to address. The feedback module 220 may send only the updated text to the AI component to identify whether it addresses the outstanding AI comments. The feedback module 220 may send all text and clarify which text is new to the AI component to identify whether it addresses the outstanding AI comments. The feedback module 220 may send all of the text to the AI component to identify whether it addresses the outstanding AI comments.

At step 470, if the user cannot submit the form due to not meeting the required threshold or critical AI comments, the feedback module 220 can continue iterating from step 430, if all AI comments are met as needed, the threshold score is met, or the user elects to override/ignore the comments, the user can submit their responses.

In one embodiment, the AI processing component may perform a method 500 and work as follows. The steps in method 500 may be performed sequentially or out of order, or may be combined.

At step 510, the AI processing component may initially receive one or more of AI initialization and information about the responses and the state of the responses. The AI initialization may include a description of the role/identity of the AI, a description of the task for the AI, and/or requirements for the AI to fulfill. The information about the responses and the state of the responses may include text from the response form, identification of new vs old text in the aforementioned text, review group which will be handling the responses, prior art related to the responses, classification or summary information about the form responses, count of times the user has updated their responses (per section), and/or previous responses provided to the user.

At step 520, the AI component may acquire additional information about the form responses prior to generating a response. For example, the additional information may include classification of the responses, prior art determined nearest to the responses, ideal review group for the form responses, which is valuable in providing clarification-specific feedback for a given review group, and/or previous user-specific feedback given which resulted in a successful form response.

The prior art nearest to the responses may be determined via a description of the topic from the user response form, via ML lookup, by filtering the above prior art based on the critical nature of the prior art closeness, and/or via description or text from the selected prior art.

The ML lookup may include embedding distance search or clustering search, topic analysis, keyword lookup, classification enhancement to the above, Z-score enhancement to the above distances for determining the critical nature of the prior art, and so forth.

The above prior art may be filtered based on the critical nature of the prior art closeness, e.g., only use critical prior art, use all critical, max of 5 high, max of 3 medium, 1 low, and/or use a certain count of prior art.

The ideal review group for the form responses, which is valuable in providing clarification-specific feedback for a given review group, may be possibly determined via expected classification, may be possibly determined via nearest prior art, may only occur at submission time to ensure clarity meets needs for review group at submission click, nearest previous form responses handled by review groups, classification of previous responses handled by review groups, and/or feedback of review groups on previous user responses.

At step 530, the AI component may then utilize the above information to curate a prompt to provide to an AI response system (e.g., a large language model). This may generate one prompt to return all responses. This may generate multiple prompts for one or more form fields or responses.

At step 540, the AI response system may then provide a response to the user, which may have one or more subcomponents. The one or more subcomponents can be broken up by form field score, comments, and/or questions. The one or more subcomponents can include summary/overall feedback on score, comments, and questions.

At step 550, the AI system may send the feedback back to the feedback module 220 or the user who requested the feedback.

In another embodiment, the feedback module 220 provides real-time feedback to inventors while filling out an invention disclosure form. The real-time feedback may both provide insights on: (1) the clarity of the disclosure in communicating the idea; (2) the separation of the disclosure from prior art; and (3) a score for the quality of the disclosure.

The clarity of the disclosure in communicating the idea may include details of how to improve communication (e.g., bullet points, numbered lists, questions about the invention, etc.), clarity for a specific reviewer/attorney, and that no feedback is necessary as the invention is clearly communicated.

The separation of the disclosure from prior art may include questions about the invention and how it separates over the prior art; instructions on aspects of the invention to elaborate on; prior art including one or more of existing patents, publications, other IDFs, internet forums, voice communications, videos, etc.; and that no feedback necessary as the separation is clear.

The score for the quality of the disclosure can be based on one or more of: clarity, prior art conflict, validity of the idea, business score evaluation, etc.

In order to achieve this, the inventor experience may look as follows. An inventor enters the invention disclosure form page. The inventor begins filling out sections of the invention disclosure. The sections may include: title, problem, solution, prior art, description, summary/abstract, novelty, business value, etc. The feedback module 220 may start to ingest the text the inventor is inputting into the form and send it to a real-time AI processing component which generates feedback for the inventor based on the ingested text and, optionally, additional contextual data (e.g., information about the inventor). Ingestion may be done on a cadence. Ingestion may be done after clicking out of a box. Ingestion may be done when x words or characters are provided. The AI processing component may generate a response and or score to provide to the inventor in real time. The response is then sent back to the invention disclosure form UI to provide to the inventor. The UI may show animated elements to show the AI processing. The UI may highlight the AI response to the inventor.

The inventor may utilize the feedback to update their disclosure. The AI may suggest that the disclosure is in a quality state and the inventor hits submit. The AI may suggest the disclosure needs updates which the inventor ignores. The feedback module 220 can prevent submission for scores below a threshold. The feedback module 220 can prevent submission until specific points are addressed (some AI comments may have varying scores for needing to be addressed; this is different from the total disclosure score). The feedback module 220 may allow an inventor override. The AI may suggest updates that the inventor attempts to address. The feedback module 220 may only send the updated text to the AI component to identify whether it addresses the outstanding AI comments. The feedback module 220 may send all text and clarify which text is new to the AI component to identify whether it addresses the outstanding AI comments. The feedback module 220 may send all of the text to the AI component to identify whether it addresses the outstanding AI comments.

If the inventor cannot submit the form due to not meeting the required threshold or critical AI comments, the feedback module 220 can continue iterating from the beginning. If all AI comments are met as needed, the threshold score is met, or the inventor may override/ignore the comments, the inventor can submit the disclosure.

In one embodiment, the AI Component works as follows. The AI component may initially receive one or more of the following: (1) AI initialization that can include a description of the role/identity of the AI, a description of the task for the AI, requirements for the AI to fulfill; and (2) information about the disclosure and the state of the disclosure, which can include text from the disclosure form, identification of new vs old text in the aforementioned text, firm which will be handling the disclosure, prior art related to the disclosure, classification or summary information about the disclosure, count of times the inventor has updated the disclosure (per section), previous responses provided to the inventor. The AI component may acquire additional information about the disclosure prior to generating a response. The additional information may include classification of the disclosure and prior art determined nearest to the patent. The prior art nearest to the patent may be determined via a description of the invention via the disclosure form, via ML lookup, by filtering the prior art based on the critical nature of the prior art closeness, or through description or text from the selected prior art. The ML lookup may be performed through embedding distance search or clustering search, topic analysis, keyword lookup, classification enhancement to the above, and Z-score enhancement to the above distances for determining the critical nature of the prior art. The above prior art may be filtered based on critical nature of the prior art closeness, e.g., only use critical prior-art, use all critical, max of 5 high, max of 3 medium, 1 low, or use a certain count of prior art. The additional information may also include ideal law firm for the disclosure. The ideal law firm may be determined via expected classification, via nearest prior art, may only occur at submission time to ensure clarity meets needs for the law firm at submission click, nearest previous invention disclosure files (IDFs) handled by law firms, classification of previous IDFs handled by law firms, or feedback of law firms on previous IDFs. This is valuable in providing clarification-specific feedback for a given law firm. The additional information may also include previous inventor-specific feedback given, which resulted in a successful patent.

The AI component may then utilize the above information to curate a prompt to provide to an AI response system (e.g., a large language model). This may generate one prompt to return all responses. This may generate multiple prompts for one or more form fields or responses.

The AI response system may then provide a response to provide back to the user which may have one more or subcomponents. The one more or subcomponents may be broken up by score, comments, questions related to the form fields. The one more or subcomponents may include summary/overall feedback on the score, comments, and questions. The AI system may send the feedback back to the system or the inventor who requested the feedback.

The mapping module 230 can map the knowledge within an enterprise based on monitored communications and/or documents. In one embodiment, the mapping module 230 can make predictions and/or recommendations based on the generated knowledge map, such as identifying overlapping knowledge to improve efficiency by reducing redundancy, aiding in determining business value for disclosures based on conversations and ideas within the organization, suggesting combinations of new ideas with previous patents and competitive analysis, and predicting new areas of research, both for the enterprise and its competitors based on extrapolation of idea flows in an embedding space.

The mapping module 230 receives data from a mechanism (e.g., the discovery module 210), idea and collects and tracks ideas within an enterprise. Technologies such as the chunking module 260 described below may aid in accurately collecting ideas within a webbed nest of concepts and context organized in a random acyclic graph of communication. In addition, the tracking module 250 described below may organize communications to aid in understanding. With such a system, one can extend these aforementioned technologies by: (1) associating these tracked ideas as institutional knowledge, (2) collating ideas together to formulate the idealized business value of a company, (3) predicting new areas of development relative to a company's capabilities and the known space of said art.

In one embodiment, the mapping module 230 uses the following data and approaches to perform a method 600. The steps in method 600 may be performed sequentially or out of order, or may be combined.

At step 610, embeddings of ideas or other mechanisms can be used to associate likeness (digitized description) between ideas or their associated content can be generated. Associated content may contain: messages describing the idea; audio, conversations or otherwise, describing or related to the idea; internal/external communication media of the idea or related concepts; images/diagrams related to the idea; and other forms of media related to the idea not yet discussed.

At step 620, embeddings or other mechanism of relation can be used to find closeness or relation between different ideas inside of a company or outside. These can be used to search for similarity or overlap of ideas. Missing space in a likeness map can be missing institutional knowledge or possible growth. Relative large gaps (to min/max spacing of the graph) can be associated with the ability to grow into the space or the need to attain knowledge externally to fill large gaps or reduce the spacing between gaps of desired concepts.

At step 630, these groupings can be associated with a larger concept. This larger concept can be generated from: groups of closeness values such as embeddings sent into a model and/or documents themselves fed into a LLM with large context and asked questions. Similar larger concepts within an organization can be associated with ideal business value for an organization. Closeness to current business value can determine the likelihood of achieving the desired business value.

At step 640, association of ideas or large concepts with individuals, teams, projects, etc., can determine overlap or redundancy or missing knowledge for a topic. Similarly, redistribution of projects can be based on institutional or work related knowledge of a team. The saddle (transfer) point of a project can be determined, e.g., when the appropriate time for moving a project from one team to another based on project state and team capabilities.

As used herein, individuals or groups can be a combination of computerized description or a single computerized description determined from all ideas/information associated with the individual or group.

The assignment module 240 can automatically assign potential inventions to portfolio managers or patent committees based on embeddings of conversations, expertise, automatic weighting based on expertise, ideas, previous patent submissions, etc. Having used the mapping module 230 to generate an ideas map of institutional knowledge, the ideas map can be used to identify the right managers, patent committees, or experts to weigh in on an idea. Similarly, the ideas map can also be used to identify the ideal counsel to assist in the evaluation or document generation surrounding the idea. Ahead of time, individuals or groups can be pre-identified as part of the possible selection criteria.

In one embodiment, when a new idea comes in, the assignment module 240 can aid the enterprise to assign the idea by performing a method 700. The steps in method 700 may be performed sequentially or out of order, or may be combined.

At step 710, the assignment module 240 determines the digitized description of the idea. At step 720, the assignment module 240 identifies the groups or individuals that are closest to the idea. When identifying the groups or individuals that are closest to the idea, likeness comparison can be 1-to-1 or in cases where many digital descriptions are associated, it can be a combined version of the digital descriptions, a voting scheme, etc.

At step 730, the assignment module 240 selects one or more individuals or groups to assess the idea. When selecting one or more individuals or groups to assess the idea, the weights of the assessment can be determined by the closeness of the digitized description of the idea to the digitized description of the assessor. The weight of the assessment can also be determined by the closeness of the individual or group to the digitized description of the ideal business value.

The tracking module 250 can provide tracking and management of ideas detected by the system. The tracking module 250 may generate a list of what IP an employee has expressed at an organization, including disclosures, trade secrets, etc. The tracking module 250 may generate a form they can sign periodically/when they leave an organization ensuring IP is protected by the company. FIG. 8 illustrates an example ideas list generated by the tracking module 250 for an employee.

Where ideas are identified as potential trade secrets, they may be added to a list and tracked by the tracking module 250. The list can be presented in a dashboard or newsfeed-type interface that provides links to relate discussions and/or documents and information about the idea, such as an indication of value, when it was last discussed, a measure of uniqueness, and the like. FIG. 9 illustrates an example dashboard listing ideas being tracked.

In various embodiments, the tracking module 250 can enable tracking of who knows what ideas based on a description, tags, and embeddings of the conversation. The tracking module 250 may trigger warnings and other notifications for internal counsel when new employees learn information. FIG. 10 illustrates an example notification generated for counsel that summarizes an idea and who has been working on it.

By monitoring communication media and/or publication of documents internal (and optionally external) to an enterprise, the tracking module 250 can track ideas or IP within the enterprise. This can be done via rudimentary means or via more complex means, such as the chunking module 260 described below.

In one embodiment, the tracking module 250 may use the following data and processes to track ideas.

When streaming or via batch analysis, the tracking module 250 can take a chunk of communication and identify whether the communication is considered an idea/IP or possibly part of an existing idea/IP. The tracking module 250 can generate a digitized description of the concept. For streaming, the tracking module 250 can determine if the communication is already associated with an idea. For example, a comment thread is already determined to be an idea, and the idea identified in the communication may be similar in concept according to digitized descriptions.

If the communication is not already associated with an idea, the communication can be fed to a quick evaluation model for determination. Then if an idea is identified in the communication, the idea can be added to a new idea. If no idea is identified in the communication, tracking module 250 can leave the communication for batch/delayed idea processing, where it may still be identified as an idea.

For batch/delayed idea processing, the tracking module 250 may use a more complex chunking algorithm to divide communication within a single medium or across varying media. The tracking module 250 can identify if the communication is already part of an existing idea. If yes, the tracking module 250 can attach the communication to the existing idea. If no, the tracking module 250 can send the communication to a model to identify a new idea. If the model can identify a new idea, the tracking module 250 can create a new idea and concept; and if the model cannot identify a new idea, the tracking module 250 do not associate the communication with an idea. The tracking module 250 can also associate the communication with the users corresponding to the idea.

For ideas being tracked, the tracking module 250 can manage who has knowledge of the idea; track where the idea is discussed; determine whether the idea should become a patent or remain a trade secret; link different discussions of the idea together; associate tags with the idea or digitized descriptions of the idea; and/or determine when an idea is being discussed outside of a protected (or expected) environment, and trigger alerts to legal as appropriate.

For individuals or groups, tracking module 250 may provide yearly reviews with concepts they know and reminders of what trade secrets are and identify competency-based training (CBTs) associated with the ideas an individual or group knows. The tracking module 250 can also be used to determine what CBTs someone should know when they move into a new area. CBTs require a digitized description no different than an idea. The tracking module 250 can generate job listings to backfill roles with missing expertise if individuals or groups are no longer with the company.

The chunking module 260 can chunk conversations to provide a better understanding and context of ideas (patents, trade secrets, etc.). Communication comes sporadically as streams of consciousness or even across different forms of communication media. Thus, to accurately identify ideas or concepts being discussed within an enterprise, the chunking module 260 links together discussions of ideas in new or batched communications to limit loss of IP within the enterprise. The chunking module 260 can use embeddings of chunks to group together conversations and/or documents (e.g., text and transcripts of conversations) within a timeframe to concatenate discussions and other information about an idea that exists within an enterprise. This can be done across mediums, such as linking together chunks of audio recordings of meetings, email threads, instant messenger discussions, text documents, and the like based on discussion of a common idea.

In one embodiment, the chunking module 260 may use the following data and processes to chunk discussions and documents and identify links between portions thereof based on the ideas discussed by performing a method 1100.

When ingesting a document or communication media, at step 1110, the chunking module 260 can break the media into smaller chunks (e.g., sentences in a document, pauses in audio, scene cuts in the video, time sequences, etc.) and develop digitized descriptions of each chunk.

At step 1120, the chunking module 260 can organize or group chunks utilizing one or more of several methods, such as the similarity of digitized descriptions; when the communication happened (temporal linearly or cyclically, ex: same time vs. same time of day/week/year); what media the communication happened over; and/or feasibility of the communication to be linked when across or within the same media. The feasibility of the communication to be linked when across or within the same media may include communications separated by too much time to be linked; different people discussing an apparently similar idea that have no link between them; discussions are in completely different threads which are unrelated; leap for the individual is unexpected given their known institutional knowledge; and so on.

The chunking module 260 can also organize, or group chunks based on that chunks may form a graph between communications where edges can be the likelihood of connection, and/or the final chunks can then be determined from developing subgraphs of the full communication graph and linking across communication mediums.

This can be done on a batch basis, e.g., only use conversations over one hour ago; only use conversations from yesterday, not at the end of the day (conversation leak between days); and so on.

At step 1130, The chunking module 260 uses the chunked text to generate embeddings and identify unique ideas over time.

The evolution module 270 tracks the progression of ideas over time. For example, evolution module 270 can identify related ideas and how they grow as they are added to or combined. The evolution module 270 may also monitor the spread of ideas within an enterprise based on who can read an idea and share it with others. Using the data generated by the various tracking techniques described above, the evolution module 270 may track the growth of an idea. This can be used to determine leak points within an organization or even the importance of an idea or new concept.

In one embodiment, the evolution module 270 tracks the progression of an idea using the following data and techniques by performing a method 1200.

At step 1210, the evolution module 270 may receive tracking data from the tracking module 250 and/or chunking module 260.

At step 1220, the evolution module 270 may keep time-series data associated with, for example, the count of communications associated with the idea, including individual knowledge or mentions of the idea and/or team/organization level knowledge or mentions of the idea; count of mentions; environments the idea is mentioned within; count of ideas determined to be related to some degree of relatedness.

At step 1230, the evolution module 270 may develop alerts on ideas related to the original idea being considered, such as similarity to the original idea, impact on business value, potential for combination with the original idea, etc.

FIG. 13 is a block diagram of an example computer 1300 suitable for use as a knowledge analysis system 110 or a client device 140. The example computer 1300 includes at least one processor 1302 coupled to a chipset 1304. The chipset 1304 includes a memory controller hub 1320 and an input/output (I/O) controller hub 1322. A memory 1306 and a graphics adapter 1312 are coupled to the memory controller hub 1320, and a display 1318 is coupled to the graphics adapter 1312. A storage device 1308, keyboard 1310, pointing device 1314, and network adapter 1316 are coupled to the I/O controller hub 1322. Other embodiments of the computer 1300 have different architectures.

In the embodiment shown in FIG. 13, the storage device 1308 is a non-transitory computer-readable storage medium such as a hard drive, compact disk read-only memory (CD-ROM), DVD, or a solid-state memory device. The memory 1306 holds instructions and data used by the processor 1302. The pointing device 1314 is a mouse, track ball, touchscreen, or other type of pointing device, and may be used in combination with the keyboard 1310 (which may be an on-screen keyboard) to input data into the computer system 1300. The graphics adapter 1312 displays images and other information on the display 1318. The network adapter 1316 couples the computer system 1300 to one or more computer networks, such as network 170.

The types of computers used by the entities of FIGS. 1 and 2 can vary depending upon the embodiment and the processing power required by the entity. For example, the knowledge analysis system 110 might include multiple blade servers working together to provide the functionality described. Furthermore, the computers can lack some of the components described above, such as keyboards 1310, graphics adapters 1312, and displays 1318.

The system disclosed herein can be dependent on a mechanism which collects and tracks ideas within a company. Technologies such as the chunking module are required to accurately collect ideas within a webbed nest of concepts and context organized in a random acyclic graph of communication. In addition, idea tracking/management module mentioned above are also required which build upon the mechanism which chunks and organizes communication for understanding.

With such a system disclosed herein, one can extend these aforementioned technologies by: (1) associating these tracked ideas as institutional knowledge, (2) collating ideas together to formulate idealized business value of a company, (3) predicting new areas of development relative to a company's capabilities and the known space of said art.

Embeddings of ideas or other mechanisms to associate likeness (digitized description) between ideas or their associated content can be generated. Associated content may contain messages describing the idea; audio, conversations or otherwise, describing or related to the idea; internal/external communication media of the idea or related concepts; images/diagrams related to the idea; and other forms of media related to the idea not yet discussed.

Embeddings or other mechanism of relation can be used to find closeness or relation between different ideas inside of a company or outside. These can be used to search for similarity or overlap of ideas. Missing space in a likeness map can be missing institutional knowledge or possible growth. Relative large gaps (to min/max spacing of the graph) can be associated with the ability to grow into the space or the need to attain knowledge externally to fill large gaps or reduce the spacing between gaps of desired concepts.

These groupings can be associated with a larger concept. This larger concept can be generated from groups of closeness values such as embeddings sent into a model and documents themselves fed into an LLM with large context and asked questions. Similar larger concepts within an organization can be associated with ideal business value for an organization. Closeness to current business value can determine the likelihood of achieving the desired business value.

The association of ideas or large concepts with individuals, teams, projects, etc. can determine overlap or, redundancy or missing knowledge for a topic. Similarly, redistribution of projects can be based on institutional or work-related knowledge of a team. Association of ideas or large concepts with individuals, teams, projects, etc. can also determine the saddle (transfer) point of a project, e.g. when the appropriate time for moving a project from one team to another based on project state and team capabilities.

Individuals or groups can be a combination of computerized descriptions and/or a single computerized description determined from all ideas/information associated with the individual or group.

The system disclosed herein can perform auto-assigning portfolio managers & patent committees based on embeddings of conversations, expertise, and automatic weighting based on expertise, ideas, previous patent submissions, etc.

Using the above mapping module of ideas/institutional knowledge, one can identify the right managers, patent committees, or experts to weigh in on an idea. Similarly, it can also be used to identify the ideal counsel to assist in the evaluation or document generation surrounding the idea. Ahead of time, individuals or groups can be pre-identified as part of the possible selection criteria. When a new idea comes in, the digitized description of the idea can be determined. The groups or individuals that are closest to the idea can be identified. Likeness comparison can be 1-to-1, or in cases where many digital descriptions are associated, it can be a combined version of the digital descriptions, voting scheme, etc. One or more individuals or groups can be selected to assess the idea. Weights of assessment can be determined by the closeness of the digitized description to the digitized description of the assessor. Weights of assessment can be determined by the closeness of the individual or group to the digitized description of the ideal business value.

For idea tracking/management, a list of what IP an employee has expressed at an organization, including disclosures, trade secrets, etc., can be generated. A form employees can sign periodically/when they leave an organization, ensuring IP is protected by the company. A list of ideas can be generated at a company, which can be added as a tracker for trade secrets and considered as a news feed of ideas. The system can track who knows what ideas based on a description, tags & embeddings of the conversation and trigger warnings for internal counsel when new employees learn information.

By monitoring communication media and/or publication of documents internal (and organization external), an organization can track ideas or IP within the organization. This can be done via rudimentary means or via more complex means, such as the chunking system described above.

Communication comes sporadically, as streams of consciousness, or even across different forms of communication media. In order to accurately identify ideas or concepts being discussed within a company a system to chunk new or batched communications must exist to limit loss of IP within an organization.

Using the idea tracking module above, one can track the growth of an idea. This can be used to determine leak points within an organization or even the importance of an idea or new concepts.

With the above mapping module, an idea map of an organization can be generated to determine who has what knowledge & then a method to remove overlapping nodes (i.e., people) from the organization. The mapping module can effectively track who knows what idea and ensure minimal redundancy, which can facilitate assigning/determining priority/objectives/projects and ensure resources are allocated based on expertise, knowledge, etc. The mapping module may take into account time of idea, etc. The mapping module can facilitate automatic determination of business value score on disclosures based on conversations and ideas within the organization, also idea combining with previous patents and competitive analysis. The mapping module can also facilitate predicting new areas of research/ideas for competitors and internally based on extrapolation of idea flows in the embedding space.

In some embodiment, an intellectual property (IP) analysis system is provided, comprising a processor and a memory having instructions stored therein. The instructions include a discovery module, a feedback module, a mapping module, an assignment module, a tracking module, a chunking module and an evolution module. When the instructions are executed by the processor, the instructions cause the processor to: monitor, by using the discovery module, communications in one or more communication media; identify, by using the discovery module, ideas in the monitored communications; enhance, by using the feedback module, form submissions by a user of an invention disclosure form related to the identified ideas; map, using the mapping module, knowledge within an enterprise based on the monitored communications and/or documents; assign, using the assignment module, potential inventions related to the identified ideas to portfolio managers or patent committees; provide, using the tracking module, tracking and management of the identified ideas; chunk, using the chunking module, the monitored communications to provide context of the identified ideas; and track, using the evolution module, progression of the identified ideas over time.

In some embodiment, the instructions further cause the processor to provide, using the discovery module, warnings where a product feature under development within the enterprise leads to infringement of an existing IP.

In some embodiment, the instructions further cause the processor to identify, using the discovery module, if one or more authors of the monitored communications have knowledge and expertise to create an invention related to the identified ideas in a given technology space.

In some embodiment, enhancing, by using the feedback module, form submissions by a user of an invention disclosure form related to the identified ideas, includes providing insights on (i) clarity of one or more form responses; (ii) form responses with respect to known topics, ideas, or communications in a similar area; or (iii) a score for quality of the form responses.

In some embodiment, the instructions further cause the processor to make predictions and/or recommendations, using the mapping module, based on a generated knowledge map.

In some embodiment, the predictions and/or recommendations include one or more of identifying overlapping knowledge to improve efficiency by reducing redundancy, aiding in determining business value for disclosures based on conversations and ideas within the enterprise, suggesting combinations of new ideas with previous patents and competitive analysis, and predicting new areas of research, both for the enterprise and its competitors based on extrapolation of idea flows in an embedding space.

In some embodiment, assigning, using the assignment module, potential inventions related to the identified ideas to portfolio managers or patent committees is based on embeddings of conversations, expertise, automatic weighting based on the expertise, the identified ideas, or previous patent submissions.

In some embodiment, the instructions further cause the processor to generate, using the tracking module, a list of what IP an employee has expressed at the enterprise, including disclosures and trade secrets.

In some embodiment, the instructions further cause the processor to track, using the tracking module, who knows what ideas based on a description, tags, and embeddings of conversations.

In some embodiment, chunking, using the chunking module, the monitored communications to provide context of the identified ideas, includes linking together discussions of ideas in new or batched communications to limit loss of IP within the enterprise.

In some embodiment, the instructions further cause the processor to monitor, using the evolution module, spread of the identified ideas within the enterprise based on who can read an idea and share it with others.

In some embodiment, a method implemented in an intellectual property (IP) analysis system is provided. The knowledge analysis system comprises a processor and a memory having instructions stored therein. The instructions include a discovery module, a feedback module, a mapping module, an assignment module, a tracking module, a chunking module and an evolution module. When the instructions are executed by the processor, the instructions cause the processor to perform the method. The method comprises: monitoring, by using the discovery module, communications in one or more communication media; identifying, by using the discovery module, ideas in the monitored communications; enhancing, by using the feedback module, form submissions by a user of an invention disclosure form related to the identified ideas; mapping, using the mapping module, knowledge within an enterprise based on the monitored communications and/or documents; assigning, using the assignment module, potential inventions related to the identified ideas to portfolio managers or patent committees; providing, using the tracking module, tracking and management of the identified ideas; chunking, using the chunking module, the monitored communications to provide context of the identified ideas; and tracking, using the evolution module, progression of the identified ideas over time.

In some embodiment, a non-transitory computer-readable medium having instructions stored thereon is provided. The instructions are implemented in an intellectual property (IP) analysis system. The knowledge analysis system comprises a processor and a memory. The instructions include a discovery module, a feedback module, a mapping module, an assignment module, a tracking module, a chunking module and an evolution module. When the instructions are executed by the processor, the instructions cause the processor to perform procedures comprising: monitoring, by using the discovery module, communications in one or more communication media; identifying, by using the discovery module, ideas in the monitored communications; enhancing, by using the feedback module, form submissions by a user of an invention disclosure form related to the identified ideas; mapping, using the mapping module, knowledge within an enterprise based on the monitored communications and/or documents; assigning, using the assignment module, potential inventions related to the identified ideas to portfolio managers or patent committees; providing, using the tracking module, tracking and management of the identified ideas; chunking, using the chunking module, the monitored communications to provide context of the identified ideas; and tracking, using the evolution module, progression of the identified ideas over time.

In some embodiments, a system may comprise a processor; and a memory having instructions stored therein. The instructions may include a discovery module, a mapping module, an assignment module, a tracking module, a chunking module and an evolution module. When the instructions are executed by the processor, the instructions may cause the processor to: monitor, by using the discovery module, documents within document repositories and communications in one or more communication media; identify, by using the discovery module, ideas in the monitored documents and communications; map, using the mapping module, knowledge within an enterprise based on the monitored documents and communications; provide, using the tracking module, tracking and management of the identified ideas; chunk, using the chunking module, the monitored documents and communications to provide context of the identified ideas; and track, using the evolution module, progression of the identified ideas over time.

In some embodiments, the instructions may further include a feedback module and cause the processor to enhance, by using the feedback module, form submissions by a user of an invention disclosure form related to the identified ideas.

In some embodiments, the instructions further cause the processor to identify, using the discovery module, if one or more authors of the monitored communications have knowledge and expertise to create an invention related to the identified ideas in a given technology space.

In some embodiments, enhancing, by using the feedback module, form submissions by a user of an invention disclosure form related to the identified ideas, includes providing the user with questions regarding technical details based upon a prior art search of previously input invention disclosure details, and framing the questions surrounding the technical details that were least likely to be present within the prior art.

In some embodiments, the instructions further cause the processor to make predictions and/or recommendations, using the mapping module, based on a generated knowledge map.

In some embodiments, the predictions and/or recommendations include one or more of identifying overlapping knowledge to improve efficiency by reducing redundancy, aiding in determining business value for disclosures based on conversations and ideas within the enterprise, suggesting combinations of new ideas with previous patents and competitive analysis, and predicting new areas of research, both for the enterprise and its competitors based on extrapolation of idea flows in an embedding space.

In some embodiments, the instructions further cause the processor to assign, using the assignment module, potential inventions related to the identified ideas to portfolio managers or patent committees, which includes (1) feeding the potential inventions into a large language model (LLM), (2) generating technology tags for each asset, (3) based on the technology tags, assigning the potential inventions to portfolio managers or patent committees with caseloads that are tagged closest to the technology tags.

In some embodiments, assigning, using the assignment module, potential inventions related to the identified ideas to portfolio managers or patent committees s based on embeddings of conversations, expertise, automatic weighting based on the expertise, the identified ideas, or previous patent submissions.

In some embodiments, the embeddings is used to get classification using a map that has been pre-generated, or is used embeddings mapped of document to embeddings associated with the managers/committees to find nearest.

In some embodiments, the expertise is generated from documents related to expertise of the managers/committees that are associated with the same or have processed the same.

In some embodiments, the expertise is generated via a variety of techniques including topic modeling and key term analysis.

In some embodiments, the instructions further cause the processor, using the tracking module, to (1) receive a request to generate a knowledge audit for an employee, (2) retrieve information related to the employee's knowledge from our database, (3) perform a query of tags/embedding/etc. within our knowledge database, and (4) return a list of matching ideas for the employee based upon the query.

In some embodiments, the instructions further cause the processor to track, using the tracking module, who knows what ideas based on a description, tags, and embeddings of conversations.

In some embodiments, chunking, using the chunking module, the monitored communications to provide context of the identified ideas, includes linking together discussions of ideas in new or batched communications to limit loss of IP within the enterprise.

In some embodiments, the instructions further cause the processor to monitor, using the evolution module, spread of the identified ideas within the enterprise based on who can read an idea and share it with others.

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate+/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by any claims that ultimately issue.

What is claimed is:

1. A system, comprising:
a processor; and
a memory having instructions stored therein, the instructions including a discovery module, a mapping module, an assignment module, a tracking module, a chunking module and an evolution module, wherein when the instructions are executed by the processor, the instructions cause the processor to:
monitor, by using the discovery module, documents within document repositories and communications in one or more communication media;
identify, by using the discovery module, ideas in the monitored documents and communications;
map, using the mapping module, knowledge within an enterprise based on the monitored documents and communications;
provide, using the tracking module, tracking and management of the identified ideas;
chunk, using the chunking module, the monitored documents and communications to provide context of the identified ideas; and
track, using the evolution module, progression of the identified ideas over time.

2. The system of claim 1, wherein the instructions further include a feedback module and cause the processor to enhance, by using the feedback module, form submissions by a user of an invention disclosure form related to the identified ideas.

3. The system of claim 1, wherein the instructions further cause the processor to identify, using the discovery module, if one or more authors of the monitored communications have knowledge and expertise to create an invention related to the identified ideas in a given technology space.

4. The system of claim 2, wherein enhancing, by using the feedback module, form submissions by a user of an invention disclosure form related to the identified ideas, includes providing the user with questions regarding technical details based upon a prior art search of previously input invention disclosure details, and framing the questions surrounding the technical details that were least likely to be present within the prior art.

5. The system of claim 1, wherein the instructions further cause the processor to make predictions and/or recommendations, using the mapping module, based on a generated knowledge map.

6. The system of claim 5, wherein the predictions and/or recommendations include one or more of identifying overlapping knowledge to improve efficiency by reducing redundancy, aiding in determining business value for disclosures based on conversations and ideas within the enterprise, suggesting combinations of new ideas with previous patents and competitive analysis, and predicting new areas of research, both for the enterprise and its competitors based on extrapolation of idea flows in an embedding space.

7. The system of claim 1, wherein the instructions further cause the processor to assign, using the assignment module, potential inventions related to the identified ideas to portfolio managers or patent committees, which includes (1) feeding the potential inventions into a large language model (LLM), (2) generating technology tags for each asset, (3) based on the technology tags, assigning the potential inventions to portfolio managers or patent committees with caseloads that are tagged closest to the technology tags.

8. The system of claim 7, wherein assigning, using the assignment module, potential inventions related to the identified ideas to portfolio managers or patent committees s based on embeddings of conversations, expertise, automatic weighting based on the expertise, the identified ideas, or previous patent submissions.

9. The system of claim 8, wherein the embeddings is used to get classification using a map that has been pre-generated, or is used embeddings mapped of document to embeddings associated with the managers/committees to find nearest.

10. The system of claim 8, wherein the expertise is generated from documents related to expertise of the managers/committees that are associated with the same or have processed the same.

11. The system of claim 8, wherein the expertise is generated via a variety of techniques including topic modeling and key term analysis.

12. The system of claim 1, wherein the instructions further cause the processor, using the tracking module, to (1) receive a request to generate a knowledge audit for an employee, (2) retrieve information related to the employee's knowledge from our database, (3) perform a query of tags/embedding/etc. within our knowledge database, and (4) return a list of matching ideas for the employee based upon the query.

13. The system of claim 1, wherein the instructions further cause the processor to track, using the tracking module, who knows what ideas based on a description, tags, and embeddings of conversations.

14. The system of claim 1, wherein chunking, using the chunking module, the monitored communications to provide context of the identified ideas, includes linking together discussions of ideas in new or batched communications to limit loss of IP within the enterprise.

15. The system of claim 1, wherein the instructions further cause the processor to monitor, using the evolution module, spread of the identified ideas within the enterprise based on who can read an idea and share it with others.

16. A method implemented in an intellectual property (IP) analysis system, comprising:
monitoring communications in one or more communication media;
identifying ideas in the monitored communications;
enhancing form submissions by a user of an invention disclosure form related to the identified ideas;
mapping knowledge within an enterprise based on the monitored communications and/or documents;
assigning potential inventions related to the identified ideas to portfolio managers or patent committees;
providing tracking and management of the identified ideas;
chunking the monitored communications to provide context of the identified ideas; and
tracking progression of the identified ideas over time.

17. The method of claim 12, further comprising providing, warnings where a product feature under development within the enterprise leads to infringement of an existing IP.

18. The method of claim 12, further comprising identifying if one or more authors of the monitored communications have knowledge and expertise to create an invention related to the identified ideas in a given technology space.

19. The method of claim 12, wherein enhancing form submissions by a user of an invention disclosure form related to the identified ideas, includes providing insights on (i) clarity of one or more form responses; (ii) form responses with respect to known topics, ideas, or communications in a similar area; or (iii) a score for quality of the form responses.

20. A non-transitory computer-readable medium having instructions stored thereon that, when executed by a processor, cause the processor to perform procedures comprising:
monitoring communications in one or more communication media;
identifying ideas in the monitored communications;
enhancing form submissions by a user of an invention disclosure form related to the identified ideas;
mapping knowledge within an enterprise based on the monitored communications and/or documents;
assigning potential inventions related to the identified ideas to portfolio managers or patent committees;
providing tracking and management of the identified ideas;
chunking the monitored communications to provide context of the identified ideas; and
tracking progression of the identified ideas over time.

21. The non-transitory computer-readable medium of claim 16, wherein assigning potential inventions related to the identified ideas to portfolio managers or patent committees is based on embeddings of conversations, expertise, automatic weighting based on the expertise, the identified ideas, or previous patent submissions.

22. The non-transitory computer-readable medium of claim 16, wherein the instructions further cause the processor to perform procedures comprising generating a list of what IP an employee has expressed at the enterprise, including disclosures and trade secrets.

23. The non-transitory computer-readable medium of claim 16, wherein the instructions further cause the processor to perform procedures comprising tracking who knows what ideas based on a description, tags, and embeddings of conversations.

24. The non-transitory computer-readable medium of claim 16, wherein chunking the monitored communications to provide context of the identified ideas, includes linking together discussions of ideas in new or batched communications to limit loss of IP within the enterprise.
